(19) United States
(12) Patent Application Publication
(10) Pub. No.: US 2007/0163311 A1
(43) Pub. Date: Jul. 19, 2007

(54) Locking device for steering wheel of car

(76) Inventors: Zhen-Lin Yang, Beidou Zhen (TW); Sheng-Jan Yang, Beidou Zhen (TW); Mu-Gui Yang, Beidou Zhen (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/333,675

(22) Filed: Jan. 17, 2006

(51) Int. Cl. B60R 25/02

(52) U.S. Cl. 70/209

(57) ABSTRACT

A locking device for the steering wheel of a car includes a mounting tube, a retractable post mounted in the mounting tube, a press type lock mounted on the mounting tube and detachably engaged with the retractable post to lock and unlock the retractable post, a first locking member mounted on the mounting tube, and a second locking member mounted on the retractable post to move therewith. Thus, the locking hooks of the first locking member and the second locking member are rotatable to fold the locking hooks when not in use so that the locking device has a smaller volume after being folded, thereby facilitating packaging, storage and transportation of the locking device.

### BACKGROUND OF THE INVENTION

1. Field of the Invention

The present invention relates to a locking device and, more particularly, to a locking device for the steering wheel of a car.

2. Description of the Related Art

A conventional locking device for the steering wheel of a car comprises a mounting tube, a retractable post mounted in the mounting tube, a lock mounted on the mounting tube and detachably engaged with the retractable post to lock and unlock the retractable post, a first locking member mounted on the mounting tube and having two locking hooks, and a second locking member mounted on the retractable post to move therewith and having two locking hooks.

In operation, when the locking device is mounted on the steering wheel of a car, the locking hooks of the first locking member are initially hooked on a first rim of the steering wheel. Then, the retractable bar is pulled outward relative to the mounting tube so that the locking hooks of the second locking member are hooked on a second rim of the steering wheel, thereby locking the steering wheel by the locking device.

However, the locking hooks of the first locking member and the second locking member have a fixed structure and cannot be folded when not in use so that the locking device has a larger volume, thereby greatly causing inconvenience in packaging, storage and transportation of the locking device. In addition, the retractable bar is easily rotatable relative to the mounting tube when the retractable bar is movable relative to the mounting tube, thereby causing inconvenience to a user when operating the locking device. Further, the lock is perpendicular to the first locking member and the second locking member to increase the whole height of the locking device largely so that the locking device has a larger volume.

### SUMMARY OF THE INVENTION

In accordance with the present invention, there is provided a locking device, comprising a mounting tube having a first end and a second end, a retractable post having a first end retractably mounted in the second end of the mounting tube, a press type lock mounted on the second end of the mounting tube and detachably engaged with the first end of the retractable post to lock and unlock the retractable post, a first locking member mounted on a mediate portion of the mounting tube, and a second locking member mounted on a second end of the retractable post to move therewith.

The primary objective of the present invention is to provide a locking device, wherein the locking hooks of the first locking member and the second locking member are rotatable relative to the catch plate to fold the locking hooks when not in use so that the locking device has a smaller volume after being folded, thereby facilitating packaging, storage and transportation of the locking device.

Another objective of the present invention is to provide a locking device, wherein the retractable bar is not rotatable relative to the mounting tube to prevent the retractable bar from being rotatable relative to the mounting tube during operation, so that the retractable bar is movable relative to the mounting tube smoothly, thereby facilitating a user operating the locking device.

A further objective of the present invention is to provide a locking device, wherein the lock is arranged in a transverse manner relative to the mounting tube and is parallel with the first locking member and the second locking member to reduce the whole height of the locking device largely so that the locking device has a smaller volume.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a locking device in accordance with the preferred embodiment of the present invention.

FIG. 2 is a partially perspective cross-sectional view of a locking member of the locking device as shown in FIG. 1.

FIG. 3 is a partially exploded perspective view of the locking member of the locking device as shown in FIG. 2.

FIG. 4 is a partially plan cross-sectional view of the locking member of the locking device as shown in FIG. 2.

FIG. 5 is a partially exploded perspective view of the locking device as shown in FIG. 1.

FIG. 6 is a plan cross-sectional assembly view of the locking device as shown in FIG. 5.

FIG. 7 is a schematic operational view of the locking device as shown in FIG. 6.

FIG. 8 is a schematic plan operational view of the locking device for the steering wheel of a car as shown in FIG. 1.

FIG. 9 is a plan cross-sectional view of the locking device as shown in FIG. 8.

FIG. 10 is a plan cross-sectional view of the locking member of the locking device as shown in FIG. 2.

FIG. 11 is a schematic plan operational view of the locking member of the locking device as shown in FIG. 10.

### DETAILED DESCRIPTION OF THE INVENTION

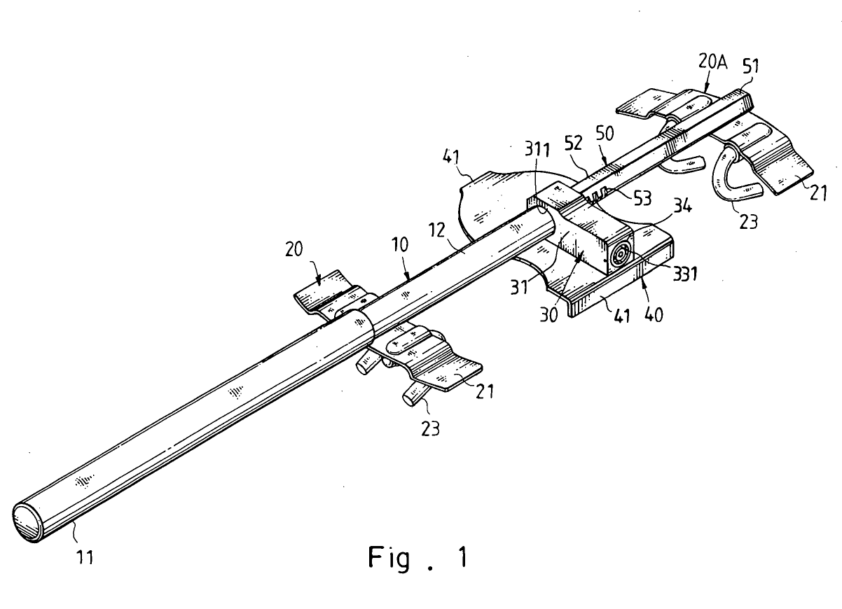

Referring to the drawings and initially to FIG. 1, a locking device for the steering wheel of a car in accordance with the preferred embodiment of the present invention comprises a mounting tube 10 having a first end 11 and a second end 12, a retractable post 50 having a first end 52 retractably mounted in the second end 12 of the mounting tube 10, a press type lock 30 mounted on the second end 12 of the mounting tube 10 and detachably engaged with the first end 52 of the retractable post 50 to lock and unlock the retractable post 50, an air bag protective cover 40 mounted on a bottom of the lock 30 to cover and protect an air bag (not shown) of the car, a first locking member 20 mounted on a mediate portion of the mounting tube 10, and a second locking member 20A mounted on a second end 51 of the retractable post 50 to move therewith.

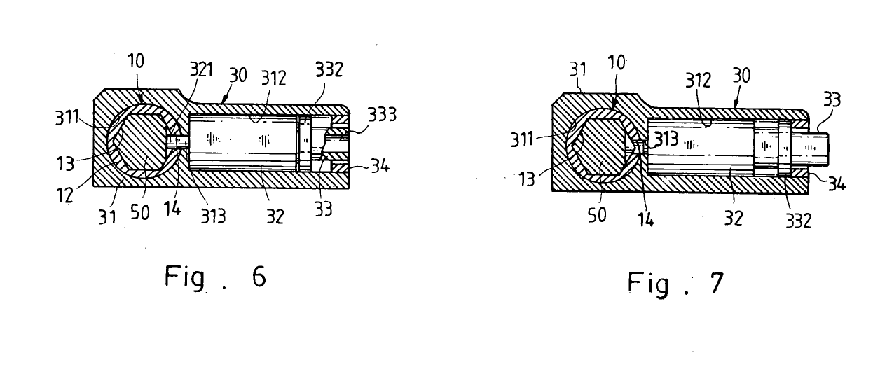

Referring to FIGS. 1 and 6, the second end 12 of the mounting tube 10 has an inside formed with an axially extending mounting hole 13 (see FIG. 6) and has a periphery formed with a radially extending passage 14 (see FIG. 6) connected to the mounting hole 13. The mounting hole 13 of the mounting tube 10 has a non-circular cross-sectional profile and preferably has a hexagonal cross-sectional profile.

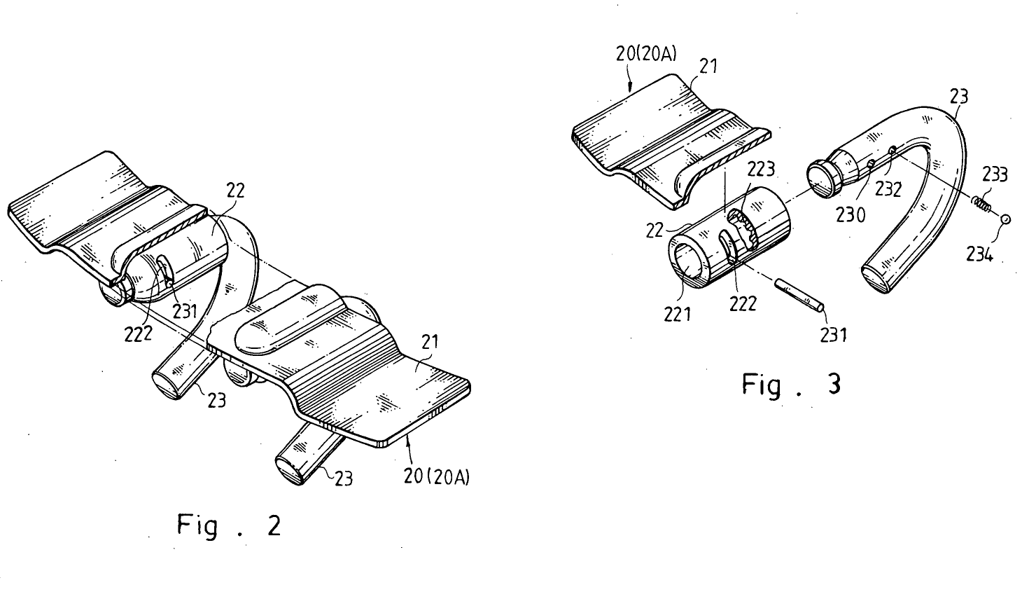

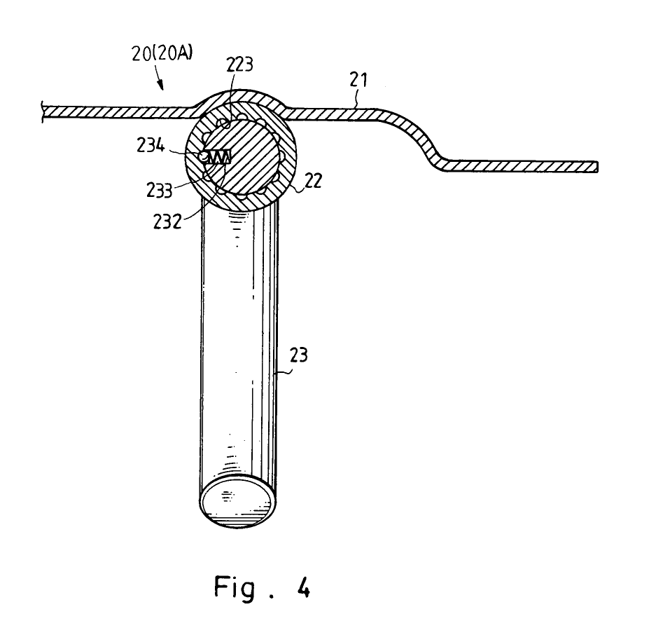

Referring to FIGS. 1-4, each of the first locking member 20 and the second locking member 20A has the same structure and includes a catch plate 21 mounted on the mediate portion of the mounting tube 10 and the second end 51 of the retractable post 50 respectively, two pivot seats 22 each mounted on the catch plate 21, and two locking hooks 23 each pivotally mounted on the respective pivot seat 22.

Each of the pivot seats 22 of each of the first locking member 20 and the second locking member 20A has a tubular shape and has an inside formed with an axially extending mounting bore 221 for mounting the respective locking hook 23. Each of the pivot seats 22 of each of the first locking member 20 and the second locking member 20A has a peripheral wall formed with a radially extending elongated limit slot 222 connected to the mounting bore 221 and has an inner wall formed with a plurality of positioning grooves 223 arranged in an annular manner.

Each of the locking hooks 23 of each of the first locking member 20 and the second locking member 20A has a curved shape and has an end portion rotatably mounted in the mounting bore 221 of the respective pivot seat 22. Thus, the locking hooks 23 of each of the first locking member 20 and the second locking member 20A are rotatable relative to the catch plate 21. The end portion of each of the locking hooks 23 has a peripheral wall formed with a pin hole 230 and a spring hole 232. The locking hooks 23 of the first locking member 20 and the second locking member 20A are directed toward different directions.

Each of the first locking member 20 and the second locking member 20A further includes two limit pins 231 each slidably mounted in the limit slot 222 of the respective pivot seat 22 and each having a distal end secured in the pin hole 230 of the respective locking hook 23 to limit rotation of the respective locking hook 23 relative to the respective pivot seat 22.

Each of the first locking member 20 and the second locking member 20A further includes two positioning balls 234 each movably mounted in the spring hole 232 of the respective locking hook 23 and each detachably positioned in either one of the positioning grooves 223 of the respective pivot seat 22 to position the respective locking hook 23 on the respective pivot seat 22 temporarily, and two springs 233 each mounted in the spring hole 232 of the respective locking hook 23 and each pressing the respective positioning ball 234 to push the respective positioning ball 234 toward the respective pivot seat 22.

Referring to FIGS. 1 and 5-7, the first end 52 of the retractable bar 50 is movably mounted in the mounting hole 13 of the mounting tube 10 and has a periphery formed with a plurality of axially extending locking grooves 53. The retractable bar 50 has a non-circular cross-sectional profile and preferably has a hexagonal cross-sectional profile. Thus, the retractable bar 50 is not rotatable relative to the mounting tube 10.

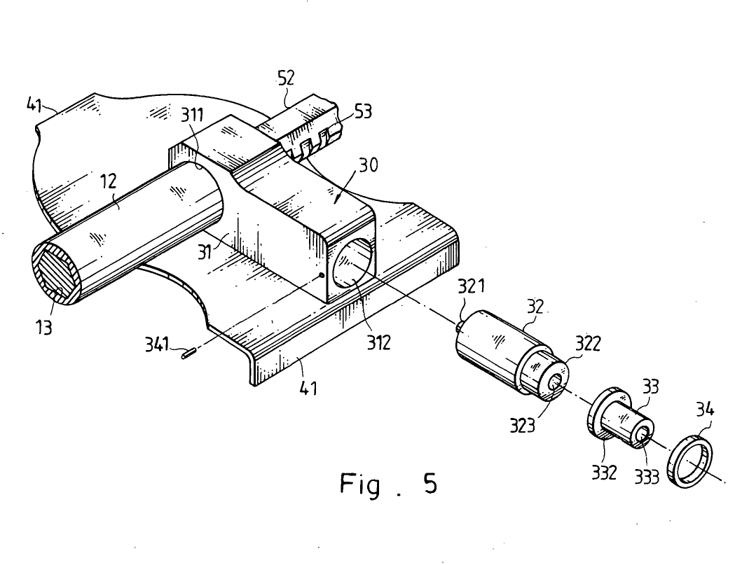

The lock 30 is arranged in a transverse manner relative to the mounting tube 10 and is parallel with the first locking member 20 and the second locking member 20A. The lock 30 includes a fixing seat 31 secured on the second end 12 of the mounting tube 10, a lock core 32 mounted in the fixing seat 31, a latch 321 mounted on a first end of the lock core 32 and movable to be extended into the mounting tube 10 and detachably locked in either one of the locking grooves 53 of the retractable bar 50, a slide 322 movably mounted on a second end of the lock core 32 and connected with the latch 321 to move the latch 321, a press member 33 partially protruded outward from the fixing seat 31 and rested on the slide 322 to push the slide 322 to move the latch 321 toward the retractable bar 50, a stop ring 34 secured in the fixing seat 31 and rested on the press member 33 to prevent the press member 33 from detaching from the fixing seat 31, and a retaining pin 341 (see FIG. 5) extended through the fixing seat 31 and rested on the stop ring 34 to retain the stop ring 34 in the fixing seat 31.

The fixing seat 31 of the lock 30 has an inside formed with an axially extending mounting chamber 312 for mounting the lock core 32, the press member 33 and the stop ring 34. The mounting chamber 312 of the fixing seat 31 has a bottom wall formed with a connecting hole 313 (see FIG. 6) connected to the passage 14 of the mounting tube 10. The fixing seat 31 of the lock 30 has an end portion formed with a transversely extending mounting hole 311 mounted on the second end 12 of the mounting tube 10.

The latch 321 of the lock 30 is extended through the connecting hole 313 of the fixing seat 31 and the passage 14 of the mounting tube 10 into the mounting hole 13 of the mounting tube 10.

The slide 322 of the lock 30 has a distal end formed with a key hole 323 that is driven by a key (not shown) to rotate the slide 322 to unlock the lock core 32 so that the slide 322 is movable outward relative to the lock core 32 to move and detach the latch 321 from the respective locking groove 53 of the retractable bar 50.

The press member 33 of the lock 30 is movably mounted in the fixing seat 31 and has an inside formed with an entrance 333 aligning with the key hole 323 of the slide 322 to allow passage of the key. The press member 33 of the lock 30 has a first end provided with an enlarged flange 332 rested on the slide 322 and movable to abut the stop ring 34 and a second end extended through the stop ring 34 and partially protruded outward from the fixing seat 31.

The air bag protective cover 40 is secured on a bottom of the fixing seat 31 of the lock 30 and has two sides each provided with a bent portion 41.

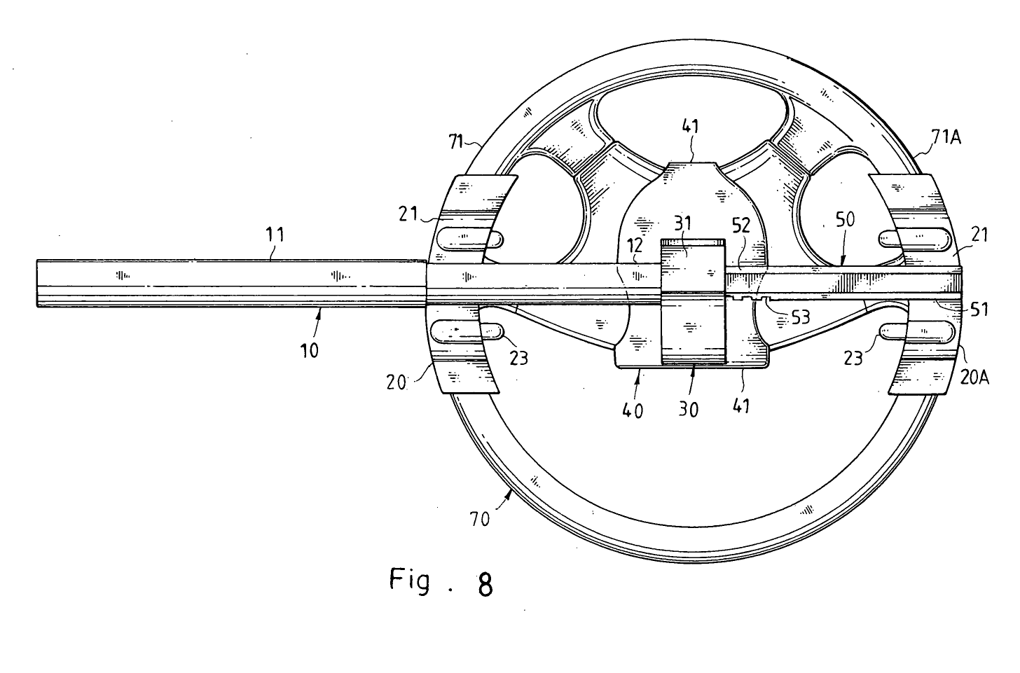

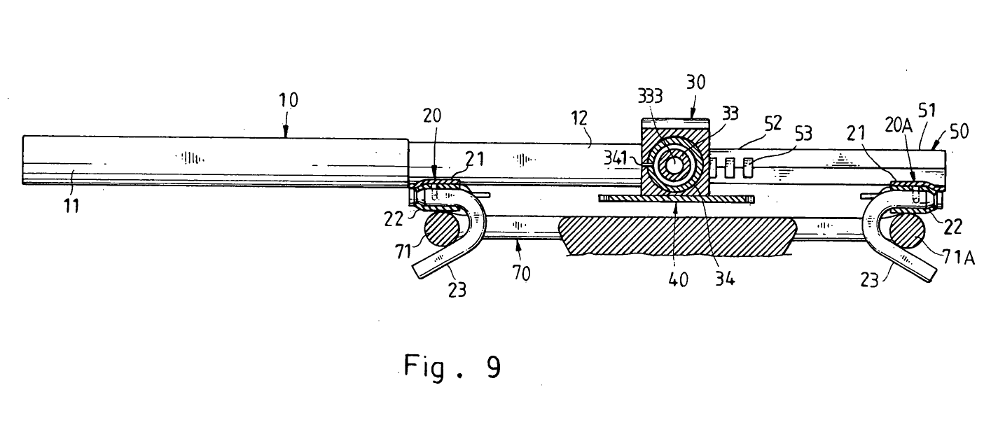

In operation, referring to FIGS. 8 and 9 with reference to FIGS. 1-7, when the locking device is mounted on the steering wheel 70 of a car, the locking hooks 23 of the first locking member 20 are initially hooked on a first rim 71 of the steering wheel 70. Then, the retractable bar 50 is pulled outward relative to the mounting tube 10 so that the locking hooks 23 of the second locking member 20A are hooked on a second rim 71A of the steering wheel 70. When the press member 33 is pushed toward the lock core 32, the slide 322 is pushed by the press member 33 to move the latch 321 toward the retractable bar 50 so that the latch 321 is locked in either one of the locking grooves 53 of the retractable bar 50 to lock the retractable bar 50 on the mounting tube 10 by the latch 321 of the lock 30, thereby locking the steering wheel 70 by the locking device as shown in FIGS. 8 and 9.

When the key is extended through the stop ring 34 and the entrance 333 of the press member 33 and inserted into the key hole 323 of the slide 322 to rotate the slide 322, the lock core 32 is unlocked so that the slide 322 is movable outward relative to the lock core 32 by a restoring action of the lock core 32 to move and detach the latch 321 from the respective locking groove 53 of the retractable bar 50 so as to unlock the retractable bar 50 from the mounting tube 10, thereby unlocking the steering wheel 70 from the locking device.

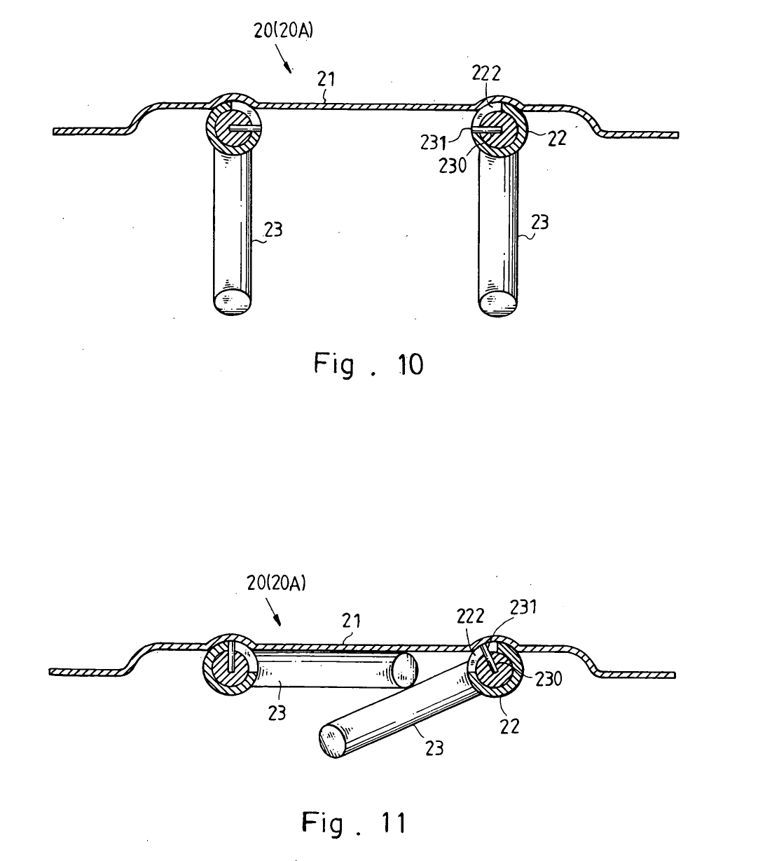

As shown in FIG. 10, each of the locking hooks 23 of each of the first locking member 20 and the second locking member 20A is rotatable relative to the catch plate 21 to be perpendicular to the catch plate 21 during operation.

As shown in FIG. 11, each of the locking hooks 23 of each of the first locking member 20 and the second locking member 20A is rotatable relative to the catch plate 21 to be closer to the catch plate 21 when not in use.

Accordingly, the locking hooks 23 of the first locking member 20 and the second locking member 20A are rotatable relative to the catch plate 21 to fold the locking hooks 23 when not in use so that the locking device has a smaller volume after being folded, thereby facilitating packaging, storage and transportation of the locking device. In addition, the retractable bar 50 is not rotatable relative to the mounting tube 10 to prevent the retractable bar 50 from being rotatable relative to the mounting tube 10 during operation, so that the retractable bar 50 is movable relative to the mounting tube 10 smoothly, thereby facilitating a user operating the locking device. Further, the lock 30 is arranged in a transverse manner relative to the mounting tube 10 and is parallel with the first locking member and the second locking member to reduce the whole height of the locking device largely so that the locking device has a smaller volume.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A locking device, comprising:
a mounting tube having a first end and a second end;
a retractable post having a first end retractably mounted in the second end of the mounting tube;
a press type lock mounted on the second end of the mounting tube and detachably engaged with the first end of the retractable post to lock and unlock the retractable post;
a first locking member mounted on a mediate portion of the mounting tube;
a second locking member mounted on a second end of the retractable post to move therewith.

2. The locking device in accordance with claim 1, wherein each of the first locking member and the second locking member has the same structure.

3. The locking device in accordance with claim 2, wherein each of the first locking member and the second locking member includes a catch plate mounted on the mediate portion of the mounting tube and the second end of the retractable post respectively, two pivot seats each mounted on the catch plate, and two locking hooks each pivotally mounted on the respective pivot seat.

4. The locking device in accordance with claim 3, wherein each of the pivot seats of each of the first locking member and the second locking member has a tubular shape and has an inside formed with an axially extending mounting bore for mounting the respective locking hook, and each of the locking hooks of each of the first locking member and the second locking member has a curved shape and has an end portion rotatably mounted in the mounting bore of the respective pivot seat, so that the locking hooks of each of the first locking member and the second locking member are rotatable relative to the catch plate.

5. The locking device in accordance with claim 3, wherein the locking hooks of the first locking member and the second locking member are directed toward different directions.

6. The locking device in accordance with claim 3, wherein each of the pivot seats of each of the first locking member and the second locking member has a peripheral wall formed with a radially extending elongated limit slot, each of the locking hooks of each of the first locking member and the second locking member has an end portion having a peripheral wall formed with a pin hole, and each of the first locking member and the second locking member further includes two limit pins each slidably mounted in the limit slot of the respective pivot seat and each having a distal end secured in the pin hole of the respective locking hook to limit rotation of the respective locking hook relative to the respective pivot seat.

7. The locking device in accordance with claim 3, wherein each of the pivot seats of each of the first locking member and the second locking member has an inner wall formed with a plurality of positioning grooves arranged in an annular manner, each of the locking hooks of each of the first locking member and the second locking member has an end portion having a peripheral wall formed with a spring hole, and each of the first locking member and the second locking member further includes two positioning balls each movably mounted in the spring hole of the respective locking hook and each detachably positioned in either one of the positioning grooves of the respective pivot seat to position the respective locking hook on the respective pivot seat temporarily, and two springs each mounted in the spring hole of the respective locking hook and each pressing the respective positioning ball to push the respective positioning ball toward the respective pivot seat.

8. The locking device in accordance with claim 1, wherein the lock is arranged in a transverse manner relative to the mounting tube and is parallel with the first locking member and the second locking member.

9. The locking device in accordance with claim 1, wherein the first end of the retractable bar has a periphery formed with a plurality of axially extending locking grooves, the lock includes a fixing seat secured on the second end of the mounting tube, a lock core mounted in the fixing seat, a latch mounted on a first end of the lock core and movable to be extended into the mounting tube and detachably locked in either one of the locking grooves of the retractable bar, a slide movably mounted on a second end of the lock core and connected with the latch to move the latch, and a press member partially protruded outward from the fixing seat and rested on the slide to push the slide to move the latch toward the retractable bar.

10. The locking device in accordance with claim 1, wherein the second end of the mounting tube has an inside formed with an axially extending mounting hole, and the first end of the retractable bar is movably mounted in the mounting hole of the mounting tube.

11. The locking device in accordance with claim 10, wherein the mounting hole of the mounting tube has a non-circular cross-sectional profile, and the retractable bar has a non-circular cross-sectional profile, so that the retractable bar is not rotatable relative to the mounting tube.

12. The locking device in accordance with claim 9, wherein the fixing seat of the lock has an inside formed with an axially extending mounting chamber for mounting the lock core and the press member.

13. The locking device in accordance with claim 12, wherein the second end of the mounting tube has an inside formed with an axially extending mounting hole and has a periphery formed with a radially extending passage connected to the mounting hole, the mounting chamber of the fixing seat has a bottom wall formed with a connecting hole connected to the passage of the mounting tube, and the latch of the lock is extended through the connecting hole of the fixing seat and the passage of the mounting tube into the mounting hole of the mounting tube.

14. The locking device in accordance with claim 9, wherein the lock further includes a stop ring secured in the fixing seat and rested on the press member to prevent the press member from detaching from the fixing seat, and a retaining pin extended through the fixing seat and rested on the stop ring to retain the stop ring in the fixing seat.

15. The locking device in accordance with claim 14, wherein the press member of the lock has a first end provided with an enlarged flange rested on the slide and movable to abut the stop ring and a second end extended through the stop ring and partially protruded outward from the fixing seat.

16. The locking device in accordance with claim 9, wherein the slide of the lock has a distal end formed with a key hole that is driven to rotate the slide to unlock the lock core so that the slide is movable outward relative to the lock core to move and detach the latch from the respective locking groove of the retractable bar.

17. The locking device in accordance with claim 16, wherein the press member of the lock is movably mounted in the fixing seat and has an inside formed with an entrance aligning with the key hole of the slide.

18. The locking device in accordance with claim 1, further comprising an air bag protective cover secured on a bottom of the lock and having two sides each provided with a bent portion.

19. The locking device in accordance with claim 9, wherein the fixing seat of the lock has an end portion formed with a transversely extending mounting hole mounted on the second end of the mounting tube.

20. The locking device in accordance with claim 9, wherein when the press member is pushed toward the lock core, the slide is pushed by the press member to move the latch toward the retractable bar so that the latch is locked in either one of the locking grooves of the retractable bar to lock the retractable bar on the mounting tube by the latch of the lock, and when the slide is rotated, the lock core is unlocked so that the slide is movable outward relative to the lock core by a restoring action of the lock core to move and detach the latch from the respective locking groove of the retractable bar so as to unlock the retractable bar from the mounting tube.
